(19) United States
(12) Patent Application Publication
(10) Pub. No.: US 2026/0359327 A1
(43) Pub. Date: Nov. 12, 2026

(54) Closed-Loop Iterative Prompt Improvement of Generative AI with Two-Class Agent Separation

(71) Applicant: Michael Raymond Cantow, Mahwah, NJ (US)

(72) Inventor: Michael Raymond Cantow, Mahwah, NJ (US)

(21) Appl. No.: 19/714,592

(22) Filed: Jun. 21, 2026

Related U.S. Application Data
(60) Provisional application No. 63/789,488, filed on Apr. 16, 2025.

(51) Int. Cl. G06F 16/332; G06Q 10/0631

(52) U.S. Cl. CPC G06F 16/3322; G06Q 10/06316

(57) ABSTRACT

A computer-implemented system improves generative AI prompt configurations through a closed loop. A generator agent class produces structured artifacts from a prompt configuration resolved through a two-tier override map. Each run is recorded in a persistent run lineage data structure capturing the user, tenant scope, generated artifact, operational log, serialized overrides, human-recorded judgment notes, and a parent-run reference forming an iteration lineage graph. An analyzer agent class, structurally distinct from the generator and implemented as a separate module, operates in two workflows: single-run drill-down and cross-run synthesis. The analyzer emits a schema-validated next-iteration action carrying per-prompt-key overrides and a parent-run reference, dispatched through a registered handler table to a successor-generation handler that invokes the generator with a merged override map.

### CROSS-REFERENCE TO RELATED APPLICATIONS

This application claims the benefit of U.S. Provisional Application No. 63/789,488, filed Apr. 16, 2025, the entire disclosure of which is incorporated herein by reference.

### FIELD OF THE INVENTION

The present invention relates to systems for closed-loop iterative improvement of generative artificial intelligence prompt configurations. More particularly, the invention relates to architectures in which a first class of artificial intelligence agent generates structured artifact variants from a parameterized prompt configuration, a second class of artificial intelligence agent, structurally distinct from the first, analyzes the variants and the prompt configuration that produced them against persistent run lineage and human-recorded judgment notes, and the second class agent emits a schema-validated structured action that dispatches a successor generation run with proposed prompt modifications, the successor run being persistently linked to its parent in an iteration lineage graph.

### BACKGROUND OF THE INVENTION

### Technical Field

The invention addresses the problem of systematic improvement of generative artificial intelligence prompt configurations through a closed loop of generation, analysis, and modification, in which a structurally separate analyzer agent consumes the outputs of a generator agent and emits structured proposals for the next generation cycle.

### Description of Related Art

Prior approaches to prompt improvement for generative artificial intelligence systems fall into three categories, each presenting deficiencies with respect to systematic closed-loop improvement of prompt configurations.

First, human-in-the-loop prompt engineering tools. Tools commonly known in the art (operational logging and prompt-management platforms used in commercial generative artificial intelligence development) provide observability over prompt invocations and permit human developers to modify prompt text manually. These tools present run histories, allow manual diffing between prompt versions, and store invocation traces. Such tools are passive observability surfaces; they do not contain a structurally separate artificial intelligence agent that consumes prior runs and proposes the next-iteration prompt configuration. The improvement loop is closed, if at all, by a human reading run output and rewriting the prompt; the artificial intelligence system itself is not enrolled in the improvement role.

Second, autonomous prompt-tuning and prompt-search systems. A separate category of prior approach automates prompt search through algorithmic exploration, including gradient-based prompt tuning, automatic prompt engineering through reinforcement learning, and random or guided prompt search over a candidate space. Such systems lack human-recorded judgment as a primary input; their objective function is a scalar quality measure computed automatically. They also lack the persistent parent-child run lineage structure that permits forensic reconstruction of the iteration history, and they do not employ structured action dispatch through a registered handler table for launching successor runs. The result is a tuning system that operates outside the controlled execution architecture of the surrounding application and that cannot be audited by a human reviewer.

Third, single-agent self-improvement loops. A further category employs a single artificial intelligence agent in dual roles, asking the same agent to both generate and self-critique its outputs. Such single-agent self-improvement is known in the art as self-reflection or self-refinement. The deficiency of single-agent self-improvement is that the analyzer role and the generator role share the same prompt-resolution path, the same context, and the same model instance, such that no structural boundary separates generation from analysis. The analyzer's improvement proposals are produced under the same biases that produced the generation, and no architectural mechanism prevents the analyzer from being prompted in ways that simply confirm the prior generation rather than critique it.

### Deficiencies of Prior Art Summarized

The cited prior approaches fail, individually and in combination, to provide the following features that are essential to systematic closed-loop prompt improvement at production scale:
1. A structurally separate analyzer agent class implemented as a distinct module from the generator agent class, with a distinct prompt contract, a distinct invocation pathway, and a distinct data access surface, such that the analyzer cannot share state or context with the generator outside of explicit, persisted artifacts.
2. A persistent run lineage data structure recording, for each generation run, the prompt overrides applied, the resulting generated artifact, the human-recorded judgment notes, and a parent-run reference forming an iteration chain or tree.
3. A two-tier prompt resolution mechanism that consults a runtime override map keyed on filename-without-extension before falling back to a filesystem default, enabling prompt modifications to be applied without modification to any calling code and without disturbance to the default prompt files.
4. A two-workflow analyzer architecture in which the analyzer operates in a single-run drill-down workflow with access to full template content and prompt diffs, and a cross-run synthesis workflow with access only to metadata and notes, the architecture enforcing context separation such that cross-run synthesis is not biased by template content.
5. A schema-validated next-iteration action emitted by the analyzer and dispatched through a registered handler table, the action launching a successor generation run with proposed prompt overrides applied and with a parent-run reference linking the successor to the originating run.

There remains a need for an architecture that provides closed-loop prompt improvement through structurally separated generator and analyzer agents operating against persistent run lineage, with human judgment captured as structured analyzer input and with schema-validated dispatch of successor generation runs.

### SUMMARY OF THE INVENTION

### What This Invention Controls: Closed-Loop Prompt Improvement Architecture

The present invention provides a closed-loop prompt improvement architecture in which a generator artificial intelligence agent and an analyzer artificial intelligence agent, implemented as structurally distinct agent classes, cooperate through a persistent run lineage to produce iterative improvements to a prompt configuration governing generation of structured artifacts.

The architecture comprises five subsystems. First, a two-tier prompt resolution subsystem that resolves each prompt request through a runtime override map keyed on filename-without-extension before falling back to a filesystem default, such that any prompt component of the generator agent may be overridden at runtime without modification to the generator's source code. Second, a persistent run lineage data structure recording, for each generation run, the user, the tenant organization, the resulting generated artifact, the operational log, the override dictionary, the human-recorded judgment notes, and a parent-run reference. Third, a batch generation subsystem that executes a plurality of generator agent invocations concurrently from a single manifest, each invocation producing a separate generated artifact under a system-owned tenant scope. Fourth, an analyzer agent class implemented as a distinct module from the generator agent class, operating in two workflows: a single-run drill-down workflow with access to full artifact content, override text, and computed prompt diffs; and a cross-run synthesis workflow with access only to run metadata, override-frequency aggregates, and human-recorded notes. Fifth, a schema-validated next-iteration action dispatched through a registered handler table, the action carrying per-prompt-key override values and a parent-run reference, the action launching a successor generation run when invoked.

### Technical Problem and Unconventional Technical Solution

The technical problem addressed by the invention is the systematic improvement of generative artificial intelligence prompt configurations under conditions in which (i) prompt configurations are large and structured (comprising multiple distinct prompt files each contributing a different fragment of the assembled prompt), (ii) the improvement signal is partly mechanical (override frequency, diff structure) and partly human (notes recording user judgment of generated artifact quality), and (iii) the improvement loop must be auditable, with forensic reconstructability from any current prompt configuration back to the originating prompt configuration through the iteration lineage.

The unconventional technical solution lies in the structural separation of the generator and analyzer agent classes combined with the persistent run lineage data structure. Conventional approaches use a single agent in both roles, producing self-confirming improvement proposals; or they use automated tuning systems that lack the human-judgment input required for production prompt engineering. The present invention separates the two roles into distinct agent classes with distinct prompt contracts and distinct data access surfaces, then captures human judgment as a first-class structured input to the analyzer's cross-run synthesis, then closes the loop through schema-validated action dispatch that launches successor generation runs with proposed overrides applied.

### Transformation of Probabilistic Output Into Structured Iteration Lineage

The present invention transforms probabilistic generator output into a structured iteration lineage by: (a) capturing every generation run with its override configuration, generated artifact, and parent-run reference in the persistent run lineage data structure; (b) requiring the analyzer agent to emit, as its next-iteration proposal, a schema-validated structured action conforming to a predetermined action schema with per-prompt-key override fields and a parent-run reference field; (c) dispatching the structured action through the registered handler table to a successor-generation handler that launches a new generator agent invocation with the override fields applied; and (d) recording the successor run in the persistent run lineage with a parent-run reference back to the originating run.

The resulting iteration lineage is a directed acyclic graph in which each node is a generation run and each edge is the structured action that produced the child node from the parent node. The graph is queryable in both directions: forward (given a parent run, retrieve all children and the override differences) and backward (given a current run, retrieve the ancestor chain back to the root). The graph forms the substrate over which the analyzer agent's cross-run synthesis operates.

### Summary of System Architecture

Referring to FIG. 1, the closed-loop prompt improvement system 1000 comprises:
a prompt override runtime subsystem 1100;
a persistent run lineage subsystem 1200;
a generator agent class 1300;
a batch generation subsystem 1400;
an analyzer agent class 1500;
a next-iteration action dispatch subsystem 1600;
a registered handler table 1700; and
a human-judgment capture subsystem 1800.

The prompt override runtime subsystem 1100 maintains an override map keyed on filename-without-extension and resolves each prompt request through a two-tier lookup, returning an override value if present in the map and falling back to a filesystem default if not. The persistent run lineage subsystem 1200 stores, for each generation run, a record comprising at least: a user identifier, a tenant organization identifier, a generated artifact reference, an operational log reference, a serialized override dictionary, a human-recorded notes field, and a parent-run reference. The generator agent class 1300 is a first artificial intelligence agent class invoked to produce structured artifacts from a prompt configuration, the prompt configuration resolved through the prompt override runtime subsystem 1100. The batch generation subsystem 1400 concurrently invokes a plurality of generator agent instances from a single manifest, each instance producing a separate generated artifact under a system-owned tenant scope. The analyzer agent class 1500 is a second artificial intelligence agent class, structurally distinct from the generator agent class 1300, configured to operate in a single-run drill-down workflow and a cross-run synthesis workflow. The next-iteration action dispatch subsystem 1600 receives a schema-validated structured action emitted by the analyzer agent class 1500, validates the action against an action schema, and dispatches the action through the registered handler table 1700 to a successor-generation handler. The human-judgment capture subsystem 1800 captures human-recorded notes for each run and persists the notes to the run lineage subsystem 1200.

### Definitions

Prompt Configuration. The complete set of prompt-text fragments consumed by a generator artificial intelligence agent to produce a structured artifact. The prompt configuration is assembled by the generator from a plurality of named prompt components, each prompt component being a string of natural-language text accompanied by formatting and content instructions.
Prompt Component. A named text fragment that contributes to a prompt configuration. Each prompt component is identified by a component key. In a preferred embodiment, the component key is the filename of the prompt component file without its extension.
Override Map. A runtime data structure mapping component keys to override-text strings. The override map is consulted by the prompt override runtime subsystem prior to falling back to the filesystem default for any prompt component.
Generation Run. A single invocation of the generator agent class that produces a generated artifact from a specified prompt configuration. Each generation run is uniquely identified, records its override map at the time of invocation, and records a reference to the generated artifact produced.
Generated Artifact. A structured artifact produced by a single generation run. In a preferred embodiment, the generated artifact is a structured execution template. The architecture is not limited to template artifacts; the artifact may be any structured artifact composed by the generator agent.
Run Lineage. A directed acyclic graph in which each node is a generation run and each edge represents a parent-child relationship between two generation runs. The parent-child relationship is established by the parent-run reference recorded on the child run at the time of invocation.
Parent-Run Reference. A field on each generation run record identifying the prior generation run from which the current run was derived. A run with a null parent-run reference is a root run. A run with a non-null parent-run reference is a derivative run.
Human-Recorded Notes. A natural-language text field associated with a single generation run, capturing human judgment of the generated artifact's quality. The notes are written by a human reviewer after inspection of the generated artifact. The notes are persisted to the run lineage and consumed as a primary input by the analyzer agent's cross-run synthesis workflow.
Generator Agent Class. A first artificial intelligence agent class configured to produce structured artifacts from a prompt configuration. The generator agent class is implemented as a distinct Python class (or equivalent class in any object-oriented programming language) and has a distinct prompt-resolution pathway, a distinct data access surface, and a distinct invocation interface.
Analyzer Agent Class. A second artificial intelligence agent class, structurally distinct from the generator agent class, configured to analyze a plurality of generation runs and emit a next-iteration structured action. The analyzer agent class is implemented as a distinct Python class (or equivalent class in any object-oriented programming language) and has a distinct prompt contract, a distinct data access surface, and a distinct invocation interface from the generator agent class.
Single-Run Drill-Down Workflow. A workflow of the analyzer agent class in which a single generation run is selected and the analyzer is provided with the full generated artifact content, the full override text for each overridden prompt component, the computed line-level diff between each override and its corresponding filesystem default, and the human-recorded notes for the run. In the drill-down workflow, the analyzer produces a single-run analysis output.
Cross-Run Synthesis Workflow. A workflow of the analyzer agent class in which a plurality of generation runs are selected and the analyzer is provided with run metadata, an override-frequency aggregate over the plurality, and the human-recorded notes for each run, but is not provided with the generated artifact content of any run. In the cross-run synthesis workflow, the analyzer produces a cross-run synthesis output that identifies patterns across the run plurality and recommends a next iteration.
Next-Iteration Structured Action. A structured object emitted by the analyzer agent class and conforming to a predetermined action schema. The next-iteration structured action carries at least: a parent-run reference field, and one or more per-prompt-key override fields specifying the proposed override values for the successor generation run.
Successor Generation Run. A generation run launched by dispatch of the next-iteration structured action through the registered handler table. The successor generation run records its parent-run reference as the originating run identified in the next-iteration structured action.
Registered Handler Table. A data structure mapping action type identifiers to handler functions. The registered handler table is consulted at dispatch time to resolve a validated structured action to its handler.
Override Frequency Aggregate. A computed structure over a plurality of generation runs, recording for each prompt component key the count of runs in which that key was overridden. The override frequency aggregate identifies which prompt components have been subject to iteration and which have remained at the system default.
Prompt Diff. A structured comparison between an override value and the corresponding filesystem default for a single prompt component, computed at the line level and reported as a set of added lines and a set of removed lines.

### BRIEF DESCRIPTION OF THE DRAWINGS

FIG. 1 is a block diagram illustrating the overall architecture of the closed-loop prompt improvement system 1000, including the prompt override runtime subsystem 1100, the persistent run lineage subsystem 1200, the generator agent class 1300, the batch generation subsystem 1400, the analyzer agent class 1500, the next-iteration action dispatch subsystem 1600, the registered handler table 1700, and the human-judgment capture subsystem 1800.

FIG. 2 is a flow diagram illustrating the two-tier prompt resolution operation of the prompt override runtime subsystem 1100, showing the lookup of a component key against the override map, the return of an override value when the key is present, and the fallback to the filesystem default when the key is absent.

FIG. 3 is a data structure diagram illustrating the persistent run lineage subsystem 1200, showing the fields of a generation run record (user identifier 1210, tenant organization identifier 1220, generated artifact reference 1230, operational log reference 1240, override dictionary 1250, human-recorded notes field 1260, and parent-run reference 1270), and showing a representative iteration lineage graph 1290 in which three derivative runs branch from a single root run.

FIG. 4 is a block diagram illustrating the two-workflow architecture of the analyzer agent class 1500, showing the single-run drill-down workflow 1510 with its data access surface including full artifact content 1512, override text 1514, prompt diff 1516, and human-recorded notes 1518; and the cross-run synthesis workflow 1520 with its restricted data access surface including run metadata 1522, override frequency aggregate 1524, and human-recorded notes 1528, but not including artifact content from any run.

FIG. 5 is a flow diagram illustrating the closed-loop iteration cycle, showing the sequence of operations from initial generation run 1610, through human-judgment capture 1620, through analyzer cross-run synthesis 1630, through next-iteration structured action emission 1640, through schema validation 1650, through dispatch to the successor-generation handler 1660, through successor generation run 1670 with parent-run reference recorded 1680, and back to human-judgment capture for the successor run.

### DETAILED DESCRIPTION OF THE INVENTION

### System Architecture Overview

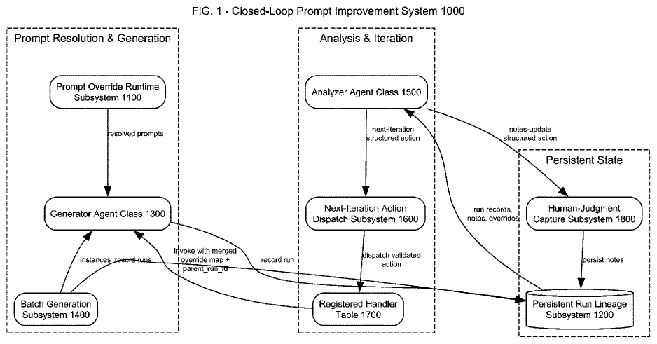

Referring to FIG. 1, the closed-loop prompt improvement system 1000 is implemented within a multi-tenant computing environment in which a plurality of tenant organizations have isolated data partitions and the system 1000 operates on behalf of the requesting user under the requesting user's tenant organization scope. The components of the system 1000 are organized into the eight subsystems identified above, each subsystem having a defined interface to the others.

The system 1000 cooperates with a controlled-execution platform incorporating by reference applicant's prior filings concerning schema-validated dispatch, registered consumer action handlers, atomic transaction execution, and chain-of-custody audit. The next-iteration structured action emitted by the analyzer agent class 1500 enters the controlled-execution platform through the registered handler table 1700 in the same manner as any other validated structured directive, such that the closed-loop prompt improvement architecture inherits the dispatch, validation, locking, and audit guarantees of the underlying platform.

### Component 1: Prompt Override Runtime Subsystem (Prompt Override Runtime Subsystem 1100)

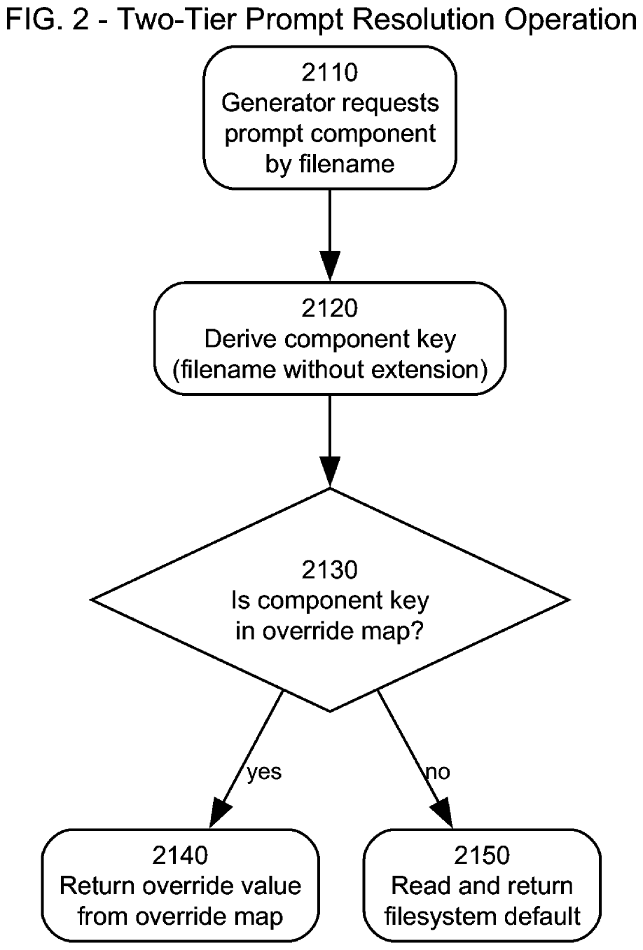

The prompt override runtime subsystem 1100 implements a two-tier prompt resolution operation invoked by the generator agent class 1300 at each prompt component request. Referring to FIG. 2, the operation comprises the following steps. At step 2110, the generator agent class requests a prompt component by its filename. At step 2120, the prompt override runtime subsystem 1100 derives a component key from the filename by removing the file extension. At step 2130, the prompt override runtime subsystem 1100 tests whether the component key is present in the override map. At step 2140, if the component key is present, the prompt override runtime subsystem 1100 returns the override value associated with that key in the override map. At step 2150, if the component key is not present, the prompt override runtime subsystem 1100 reads and returns the content of the filesystem default file at the configured prompts directory.

The two-tier resolution operation is invariant to the calling context: the same operation services every prompt component request, regardless of whether the request originates from the generator agent class 1300 during a generation run, from the analyzer agent class 1500 when constructing diffs against system defaults, or from any other consumer of the prompt component set. Each prompt component is therefore independently overridable without modification to the calling code; the override map dictates which components are overridden and which fall back to defaults on a per-component basis.

In a preferred embodiment, the override map is a Python dictionary materialized on the generator agent instance at instantiation time and discarded at the end of the generation run. In a further preferred embodiment, the override map is reconstructed from a persisted override dictionary recorded on a prior generation run, such that re-invocation of the prompt resolution against the same persisted override dictionary produces identical results.

A real-world implementation of the two-tier prompt resolution operation is found in the accompanying codebase in the ‘_load_prompt’ method of the ‘CustomerNodeCreateGPT’ base class, which consults a ‘self. prompt_overrides’ dictionary keyed on filename-without-extension before reading the file from the prompts directory.

### Component 2: Persistent Run Lineage Subsystem (Persistent Run Lineage Subsystem 1200)

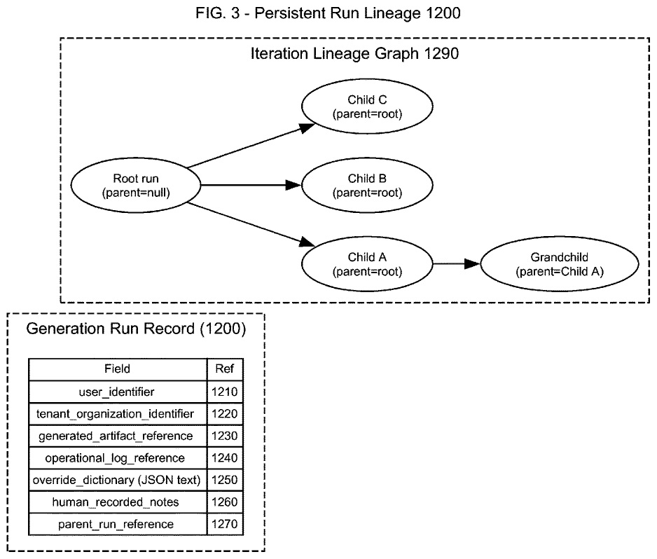

The persistent run lineage subsystem 1200 implements the data structure that records each generation run and that establishes the parent-child relationships forming the iteration lineage graph. Referring to FIG. 3, each generation run record comprises the following fields.

A user identifier 1210 identifying the human user under whose authority the generation run was invoked. A tenant organization identifier 1220 identifying the tenant organization scope in which the generation run executed. A generated artifact reference 1230 identifying the structured artifact produced by the generation run; in a preferred embodiment, the generated artifact reference is a foreign key to the artifact's row in the application data store. An operational log reference 1240 identifying the operational trace log captured during the generation run; in a preferred embodiment, the operational log reference is a foreign key to a log record capturing each step of the generation pipeline. An override dictionary 1250 storing the serialized override map applied at the time of invocation; in a preferred embodiment, the override dictionary is a JSON-encoded text field, such that addition of new override keys does not require schema migration. A human-recorded notes field 1260 storing the natural-language notes written by a human reviewer after inspection of the generated artifact. A parent-run reference 1270 identifying the prior generation run, if any, from which the current generation run was derived; the parent-run reference is null for root generation runs.

The persistent run lineage subsystem 1200 supports queries in both directions. Forward queries retrieve all descendants of a given generation run, ordered by creation time and by parent-run reference, producing the iteration subtree rooted at the given run. Backward queries retrieve the ancestor chain of a given generation run by traversing parent-run references until a root run (with null parent-run reference) is reached.

In a preferred embodiment, the persistent run lineage subsystem 1200 is implemented as a relational database table with a self-referential foreign key on the parent-run reference field, a foreign key to the generated artifact table, a foreign key to the operational log table, and a free-text column for the human-recorded notes. A representative iteration lineage graph 1290 is illustrated in FIG. 3, showing three derivative runs branching from a single root run, each derivative run carrying a distinct override dictionary and a distinct generated artifact reference.

A real-world implementation of the persistent run lineage subsystem 1200 is found in the accompanying codebase in the ‘PlatinumPromptRun’ Django model, which includes fields for user, tenant organization, the resulting cNode (the generated artifact), the AiCreatorLog (the operational log), the serialized override dictionary, the user-editable notes, and a self-referential parent foreign key.

### Component 3: Generator Agent Class (Generator Agent Class 1300)

The generator agent class 1300 is a first artificial intelligence agent class implemented as a distinct module that consumes a prompt configuration through the prompt override runtime subsystem 1100 and produces a generated artifact. The generator agent class is invoked with at least the following parameters: a task identifier, a requesting user, a target tenant organization scope, a structured input describing the artifact to be generated, a runtime override map, and an optional parent-run reference identifying the prior run from which the current invocation is derived.

In a preferred embodiment, the generator agent class is implemented as a subclass of a base agent class that provides the two-tier prompt resolution operation described in Component 1. The generator agent class consumes a plurality of named prompt components from the prompt override runtime subsystem 1100, assembles the components into a complete prompt configuration, transmits the assembled prompt configuration to a probabilistic generative model interface, and processes the model's structured output into the generated artifact persisted to the application data store.

At the conclusion of the generation run, the generator agent class invokes the persistent run lineage subsystem 1200 to record the run, passing at minimum the requesting user, the target tenant organization, a reference to the generated artifact, a reference to the operational log captured during the run, the serialized override dictionary applied, and the parent-run reference passed to the generator at invocation.

A real-world implementation of the generator agent class 1300 is found in the accompanying codebase in the ‘AiJourneyCreator2’ class within the ‘core/platform/first_party_ai/Agents/Create/creator/’ package, which accepts ‘prompt_overrides’ and ‘parent_run_id’ parameters and persists a ‘PlatinumPromptRun’ record on completion.

### Component 4: Batch Generation Subsystem (Batch Generation Subsystem 1400)

The batch generation subsystem 1400 enables concurrent invocation of a plurality of generator agent instances from a single declarative manifest, each instance producing a separate generated artifact. The manifest is a structured document listing a plurality of generation entries, each entry comprising at minimum a unique entry identifier and the structured input parameters for a single generation run. In a preferred embodiment, the manifest is a JavaScript Object Notation file maintained as the source of truth for a curated collection of generation specifications.

The batch generation subsystem 1400 processes the manifest entries in concurrent chunks of a configurable batch size. For each entry, the batch generation subsystem 1400 creates a fresh generated-artifact container under a system-owned tenant organization scope, instantiates a generator agent class instance with the entry's input parameters and an entry-specific override map (which may be empty for a default-prompts run), invokes the generator's pipeline, and updates the manifest entry's status field upon completion or failure.

The batch generation subsystem 1400 maintains a module-level stop signal that may be set by an administrative interface; upon completion of the current concurrent chunk, the subsystem tests the stop signal and exits if set, leaving remaining manifest entries unprocessed. The batch generation subsystem 1400 additionally maintains a progress aggregate (current chunk index, total chunks, chunk-completed count, chunk-total count) accessible by polling.

A real-world implementation of the batch generation subsystem 1400 is found in the accompanying codebase in the ‘gallery_batch_runner’ module, which processes a gallery JSON manifest of template generation entries through concurrent chunked invocation of the generator agent class.

### Component 5: Analyzer Agent Class (Analyzer Agent Class 1500)

The analyzer agent class 1500 is a second artificial intelligence agent class, structurally distinct from the generator agent class 1300. The structural distinction is realized in the implementation through at least the following properties: the analyzer agent class is defined as a separate class (rather than as a method or mode of the generator agent class); the analyzer agent class has a distinct constructor accepting distinct parameters (the user and tenant organization scope, without any direct reference to a target generated artifact); the analyzer agent class has a distinct prompt-resolution pathway loading prompts from a distinct prompts directory; and the analyzer agent class has a distinct data access surface composed of methods that query the persistent run lineage subsystem 1200 rather than methods that produce new generated artifacts.

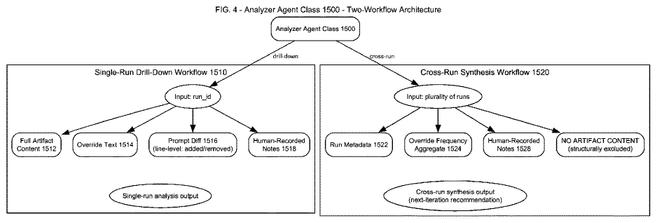

Referring to FIG. 4, the analyzer agent class 1500 operates in two structurally distinct workflows.

The single-run drill-down workflow 1510 is invoked when the analyzer is asked to analyze a single generation run identified by its run identifier. The drill-down workflow's data access surface comprises: the full generated artifact content 1512 retrieved from the application data store; the full override text 1514 for each prompt component overridden in the selected run; the prompt diff 1516 between each override text and the corresponding filesystem default, computed at the line level by the analyzer agent class as a set of added lines and a set of removed lines; and the human-recorded notes 1518 for the selected run.

The cross-run synthesis workflow 1520 is invoked when the analyzer is asked to synthesize patterns across a plurality of generation runs. The cross-run synthesis workflow's data access surface is intentionally restricted: it comprises run metadata 1522 (run identifier, generated artifact name, creation time, notes-present flag), the override frequency aggregate 1524 computed across the plurality of runs, and the human-recorded notes 1528 for each run with notes. The cross-run synthesis workflow does not include generated artifact content from any run.

The asymmetric data access surfaces between the two workflows are structurally enforced. The drill-down workflow's data-loading function returns artifact content; the cross-run workflow's data-loading function does not. Each workflow corresponds to a distinct prompt prepared for the analyzer that frames the analyzer's role and instructs the analyzer to operate only on the data provided in that workflow. The cross-run synthesis workflow is intentionally restricted from accessing artifact content because the cross-run synthesis is intended to identify patterns at the prompt-configuration level (which override sets correlate with positive human-recorded notes), not patterns at the generated-content level. Restricting artifact access in cross-run synthesis prevents the analyzer's recommendations from being biased by surface-level artifact features (vocabulary choices, formatting preferences) rather than the prompt-configuration causes of artifact quality.

A real-world implementation of the analyzer agent class 1500 is found in the accompanying codebase in the ‘AiPlatinumIterationCoach’ class, which inherits from the same ‘CustomerNodeCreateGPT’ base class as the generator (sharing the two-tier prompt resolution mechanism) but is implemented as a distinct class with distinct constructor parameters (the user and the tenant organization identifier), a distinct prompts directory, distinct data-loading methods (‘_get_runs_for_prompt’, ‘_get_run_detail’, ‘_build_history_synthesis’), and distinct workflow-specific prompt-construction methods (‘_prompt_template_drill’, ‘_prompt_history_drill’, ‘_prompt_step2’).

### Component 6: Next-Iteration Action Dispatch Subsystem (Next-Iteration Action Dispatch Subsystem 1600)

The next-iteration action dispatch subsystem 1600 receives a structured action emitted by the analyzer agent class 1500, validates the action against a predetermined action schema, and dispatches the validated action through the registered handler table 1700 to a successor-generation handler.

The next-iteration structured action is a structured object conforming to an action schema comprising at least the following fields: an action type identifier identifying the action as a next-iteration action; a parent-run reference identifying the prior generation run from which the successor run is to be derived; one or more per-prompt-key override fields specifying the proposed override values for the successor generation run, each override field identified by a prompt-component key matching the keys used by the prompt override runtime subsystem 1100; and an optional notes field recording the analyzer's rationale for the proposed override values.

In a preferred embodiment, the next-iteration structured action is emitted by the analyzer agent class 1500 as a structured user-interface element rendered into the analyzer's response, the structured element comprising a clickable button whose attributes encode the action's fields. The structured user-interface element is consumed by the controlled-execution platform's structured-action ingestion pipeline, which parses the action attributes into a structured action object and submits the object to the next-iteration action dispatch subsystem 1600.

The next-iteration action dispatch subsystem 1600 validates the structured action against the action schema. Validation comprises at minimum: confirmation that the action type identifier is the registered next-iteration action type; confirmation that the parent-run reference identifies an existing generation run; and confirmation that each per-prompt-key override field is identified by a known prompt-component key. Validation failure produces no successor generation run and no modification to the persistent run lineage.

Upon successful validation, the next-iteration action dispatch subsystem 1600 resolves the action to the successor-generation handler via the registered handler table 1700. The successor-generation handler invokes a fresh generator agent class instance with: the original generation input parameters retrieved from the parent run record; an override map constructed by merging the parent run's override dictionary with the per-prompt-key override fields of the next-iteration action; and the parent-run reference field of the next-iteration action passed as the successor's parent-run reference.

### Component 7: Registered Handler Table (Registered Handler Table 1700)

The registered handler table 1700 is the controlled-execution platform's dispatch table extended with a successor-generation handler that consumes validated next-iteration structured actions and launches successor generation runs. The handler is registered through the same registration interface used by other handlers in the controlled-execution platform; the next-iteration action is therefore subject to the same dispatch validation, atomic transaction execution, and chain-of-custody audit as any other handled action.

In a preferred embodiment, the registered handler table 1700 includes a ‘next_iteration_run’ handler entry whose target is a callable accepting the validated next-iteration structured action and producing a successor generation run by invocation of the batch generation subsystem 1400 (when the successor run is one of a plurality) or by direct invocation of the generator agent class 1300 (when the successor run is a single run).

### Component 8: Human-Judgment Capture Subsystem (Human-Judgment Capture Subsystem 1800)

The human-judgment capture subsystem 1800 provides the interface through which a human reviewer records natural-language judgment of a generated artifact and persists the judgment to the run lineage. In a preferred embodiment, the human-judgment capture subsystem 1800 is integrated with the analyzer agent class 1500's drill-down workflow: when the analyzer presents the generated artifact content, the prompt diffs, and the override text to the user, the analyzer additionally invites the user to record notes. The user's natural-language notes are captured through a structured action analogous to the next-iteration action: a structured user-interface element rendered into the analyzer's response, whose attributes encode the target run identifier and the notes text, and which is consumed by the controlled-execution platform's structured-action ingestion pipeline and dispatched through the registered handler table 1700 to a notes-update handler.

The notes-update handler persists the notes to the human-recorded notes field 1260 of the target run record in the persistent run lineage subsystem 1200. The notes become available to the analyzer agent class 1500′s cross-run synthesis workflow on subsequent invocations.

### The Closed-Loop Iteration Cycle

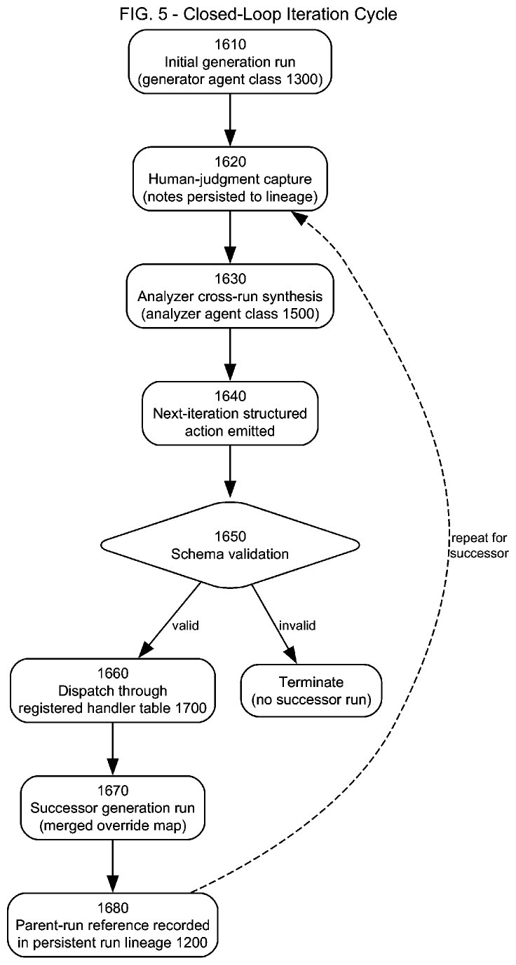

Referring to FIG. 5, the closed-loop iteration cycle proceeds as follows. At step 1610, an initial generation run is performed, either through direct invocation of the generator agent class 1300 with default prompts or through invocation of the batch generation subsystem 1400 from a manifest. The initial generation run produces a generated artifact and records a generation run record in the persistent run lineage subsystem 1200 with a null parent-run reference.

At step 1620, the human-judgment capture subsystem 1800 captures human-recorded notes for the initial generation run; the notes are persisted to the run lineage record. Step 1620 may be repeated for each of a plurality of initial generation runs invoked through the batch generation subsystem 1400.

At step 1630, the analyzer agent class 1500 is invoked in the cross-run synthesis workflow over the plurality of initial generation runs. The analyzer reads the run metadata, the override frequency aggregate, and the human-recorded notes, and produces a cross-run synthesis output identifying patterns and recommending a next iteration.

At step 1640, the analyzer agent class 1500 emits a next-iteration structured action conforming to the action schema. The structured action specifies the parent-run reference (one of the prior generation runs identified by the analyzer as the basis for the next iteration), the per-prompt-key override fields (the proposed override values), and an optional rationale notes field.

At step 1650, the next-iteration action dispatch subsystem 1600 validates the structured action against the action schema. Validation failure terminates the cycle without effect; validation success proceeds to step 1660.

At step 1660, the validated structured action is dispatched through the registered handler table 1700 to the successor-generation handler.

At step 1670, the successor-generation handler invokes the generator agent class 1300 with the override map constructed from the parent run's override dictionary merged with the next-iteration action's per-prompt-key override fields, and with the parent-run reference set to the parent run identified in the next-iteration action.

At step 1680, the successor generation run completes and records a generation run record in the persistent run lineage subsystem 1200 with the parent-run reference recorded. The cycle returns to step 1620 with the successor generation run available for human-judgment capture and subsequent analyzer invocation.

### Non-Obvious Combination Effects

The combination of the eight subsystems produces effects that none of the individual subsystems achieves alone.
First, structural prevention of generator-analyzer collusion. The structural separation of the generator agent class 1300 and the analyzer agent class 1500 into distinct classes with distinct data access surfaces prevents the analyzer from sharing internal state with the generator. The analyzer cannot access the generator's intermediate reasoning, the generator's in-flight prompt construction, or the generator's model invocation parameters; the analyzer's only inputs are the persisted artifacts of completed runs. Conventional single-agent self-improvement architectures permit the analyzer role to inherit the generator's biases through shared state; the present architecture prevents this by construction.
Second, audit-grade iteration provenance. The persistent run lineage subsystem 1200 records every generation run with its override dictionary and parent-run reference. The iteration history is forensically reconstructable from any current run back to the root run, with every override change attributable to the analyzer-emitted structured action that introduced it. No iteration step is unrecorded; no prompt change is anonymous.
Third, deterministic re-execution from persisted overrides. Because each generation run records its complete override dictionary, any historical run may be re-executed against the original input by constructing a generator instance with the persisted override map. This enables regression testing of prompt changes, comparative analysis of model versions against fixed prompt configurations, and forensic reproduction of any historical generated artifact.
Fourth, human judgment as first-class analyzer input. The human-recorded notes field 1260 is consumed by the analyzer's cross-run synthesis workflow as a primary input, not as a downstream filter. The analyzer's recommendations are grounded in human judgment of artifact quality rather than in an automatically-computed quality scalar that may not capture the qualitative properties the human reviewer actually values. This is structurally distinct from autonomous prompt-tuning architectures that operate against an automatic objective function.
Fifth, controlled-execution platform inheritance. The next-iteration action is dispatched through the same registered handler table 1700 as other validated structured directives in the controlled-execution platform. The closed-loop prompt improvement architecture inherits the platform's dispatch validation, atomic transaction execution, chain-of-custody audit, and permission gating without requiring any of these mechanisms to be re-implemented within the prompt improvement architecture. This structural reuse is enabled by the schema-validated structured action design.

### Improvement Over Prior Art

The improvements provided by the present invention over the cited prior art are as follows.
Over human-in-the-loop prompt engineering tools: the present invention provides an artificial intelligence agent in the analyzer role, capable of cross-run synthesis at scale across run histories larger than a human reviewer can hold in working memory, and capable of emitting structured next-iteration proposals without requiring the human to manually compose the override changes.
Over autonomous prompt-tuning systems: the present invention captures human judgment as a first-class input to the iteration cycle and provides forensically auditable iteration lineage. The human reviewer retains control over which iteration directions are valuable; the artificial intelligence analyzer accelerates the search through proposed override changes.
Over single-agent self-improvement loops: the present invention separates the generator and analyzer into structurally distinct agent classes, preventing the analyzer's improvement proposals from inheriting the generator's biases through shared state. The analyzer's data access surface is composed of persisted run artifacts, not in-flight generator state.

### Prototype Evidence

The components of the invention are implemented in a prototype that forms part of the accompanying codebase. Specific references are provided below.
Prompt override runtime subsystem. Implemented in the ‘_load_prompt’ method of ‘core/platform/first_party_ai/Agents/Create/_CustomerNodeCreateGPT.py’. The method consults ‘self. prompt_overrides’ (a Python dictionary keyed on filename-without-extension) before falling back to a filesystem read from the configured prompts directory.
Persistent run lineage subsystem. Implemented in the ‘PlatinumPromptRun’ Django model in ‘core/cnode/domain/models.py’. The model includes foreign keys to the user, tenant organization, generated artifact (‘cnode’), and operational log (‘ai_creator_log’); a text field for the serialized override dictionary (‘overrides_json’); a text field for user-editable notes; and a self-referential foreign key (‘parent’) forming the iteration lineage graph.
Generator agent class. Implemented in ‘AiJourneyCreator2’ in ‘core/platform/first_party_ai/Agents/Create/creator/aiJourneyCreator2.py’. The class accepts ‘prompt_overrides’ and ‘parent_run_id’ constructor parameters and persists a ‘PlatinumPromptRun’ record at the end of each generation run.
Batch generation subsystem. Implemented in ‘gallery_batch_runner.py’ in ‘core/platform/first_party_ai/Agents/Create/’. The module processes a gallery JSON manifest through concurrent chunked invocation of the generator agent class, with per-entry status tracking, stop signaling, and progress polling.
Analyzer agent class. Implemented in ‘AiPlatinumIterationCoach’ in ‘core/platform/first_party_ai/Agents/Create/coaches/aiPlatinumIterationCoach.py’. The class is structurally distinct from ‘AiJourneyCreator2’: it has distinct constructor parameters (user, organization identifier), a distinct prompts directory, distinct data-loading methods, and distinct workflow-specific prompt-construction methods for the single-run drill-down and cross-run synthesis workflows.
Next-iteration action. Implemented as the “Fire New Iteration” structured user-interface element in the analyzer's response, with per-key override attributes (one HTML data attribute per prompt component key) and a parent-run reference attribute. The element is consumed by the structured-action ingestion pipeline and dispatched through the controlled-execution platform's handler registry.
Human-judgment capture. Implemented as the “Update Run Notes” structured user-interface element in the analyzer's response, with target-run-identifier and notes-text attributes. The element is consumed by the same structured-action ingestion pipeline and dispatched to a notes-update handler that persists the notes to the ‘PlatinumPromptRun. notes’ field.

### INDUSTRIAL APPLICABILITY

The closed-loop prompt improvement architecture has industrial applicability across multiple domains in which generative artificial intelligence produces structured artifacts and the prompt configurations governing generation require systematic improvement. Representative non-limiting applications include: structured execution template generation (the prototype embodiment); clinical care plan generation from treatment-modality plugins; insurance claim form generation; procurement contract generation; compliance audit report generation; curriculum and lesson-plan generation; software code generation from natural-language specifications; report and document generation in regulated industries; and any application in which prompt configurations are large, structured, and require iterative improvement at production scale with audit-grade lineage.

1. A computer-implemented system for closed-loop iterative improvement of a prompt configuration governing a generative artificial intelligence agent, the system comprising: a prompt override runtime subsystem maintaining an override map that maps prompt component keys to override-text values, the prompt override runtime subsystem configured to resolve each prompt component request by returning the override value when the requested component key is present in the override map and by returning a filesystem default when the requested component key is not present in the override map; a persistent run lineage subsystem configured to store, for each generation run, a record comprising at least a user identifier, a tenant organization identifier, a generated artifact reference, an operational log reference, a serialized override dictionary, a human-recorded notes field, and a parent-run reference; a generator agent class implemented as a first artificial intelligence agent class configured to produce a structured artifact from a prompt configuration resolved through the prompt override runtime subsystem and to record a generation run in the persistent run lineage subsystem upon completion; an analyzer agent class implemented as a second artificial intelligence agent class structurally distinct from the generator agent class, the analyzer agent class operating in a single-run drill-down workflow with a first data access surface comprising full content of the generated artifact, override text for each overridden prompt component, computed prompt diffs between override text and filesystem defaults, and human-recorded notes, and operating in a cross-run synthesis workflow with a second data access surface comprising run metadata, an override frequency aggregate, and human-recorded notes, the second data access surface excluding generated artifact content; a next-iteration action dispatch subsystem configured to receive a next-iteration structured action emitted by the analyzer agent class, validate the next-iteration structured action against a predetermined action schema declaring at least an action type identifier, a parent-run reference field, and one or more per-prompt-key override fields, and dispatch the validated next-iteration structured action through a registered handler table to a successor-generation handler; and a registered handler table comprising a successor-generation handler configured to, upon dispatch of a validated next-iteration structured action, invoke the generator agent class with an override map constructed from per-prompt-key override fields of the next-iteration structured action and with the parent-run reference of the next-iteration structured action recorded as the parent-run reference of the successor generation run.

2. A computer-implemented system for separating generator and analyzer artificial intelligence roles in iterative prompt improvement, the system comprising: a generator agent class implemented as a first artificial intelligence agent class having a first constructor signature accepting generation input parameters, having a first prompt-resolution pathway, having a first data access surface comprising methods that produce generated artifacts, and having a first prompts directory storing default prompt component files consumed by the generator agent class; an analyzer agent class implemented as a second artificial intelligence agent class distinct from the generator agent class, the analyzer agent class having a second constructor signature accepting an analysis scope identifier and not accepting a target generated artifact reference, having a second prompt-resolution pathway distinct from the first prompt-resolution pathway, having a second data access surface comprising methods that query a persistent run lineage subsystem and do not produce generated artifacts, and having a second prompts directory distinct from the first prompts directory; and a runtime enforcement of the structural distinction wherein the analyzer agent class is invocable independently of the generator agent class, wherein the analyzer agent class does not share runtime state with any concurrently executing generator agent class instance, and wherein the analyzer agent class's only inputs concerning generation runs are records retrieved from the persistent run lineage subsystem.

3. A computer-implemented method for closed-loop iterative improvement of a prompt configuration of a generative artificial intelligence agent, the method comprising: invoking a generator agent class to produce a first generated artifact, the generator agent class consuming a first prompt configuration assembled from a plurality of prompt components resolved through a two-tier prompt resolution operation against an override map and a filesystem default; recording a first generation run in a persistent run lineage subsystem, the first generation run record comprising at least a reference to the first generated artifact, a serialized override dictionary corresponding to the override map applied, and a parent-run reference; receiving, from a human reviewer, notes recording judgment of the first generated artifact and persisting the notes to a human-recorded notes field of the first generation run record; invoking an analyzer agent class structurally distinct from the generator agent class to perform cross-run synthesis over a plurality of generation runs including the first generation run, the cross-run synthesis comprising loading run metadata, computing an override frequency aggregate over the plurality of generation runs, loading human-recorded notes for each of the plurality of generation runs, and producing a cross-run synthesis output identifying patterns and recommending a next iteration, the cross-run synthesis being performed without loading generated artifact content from any of the plurality of generation runs; receiving a next-iteration structured action emitted by the analyzer agent class, the next-iteration structured action conforming to an action schema and comprising at least a parent-run reference field and one or more per-prompt-key override fields; validating the next-iteration structured action against the action schema, including confirming that the parent-run reference identifies an existing generation run and that each per-prompt-key override field is identified by a known prompt-component key; upon successful validation, dispatching the next-iteration structured action through a registered handler table to a successor-generation handler; invoking the successor-generation handler to launch a successor generation run with an override map constructed from per-prompt-key override fields of the next-iteration structured action and with the parent-run reference of the next-iteration structured action recorded as the parent-run reference of the successor generation run; and recording the successor generation run in the persistent run lineage subsystem with the parent-run reference recorded.

4. The system of claim 1, wherein the prompt component keys are derived from the filenames of prompt component files in a prompts directory by removing a filename extension, and wherein the two-tier resolution operation services requests from both the generator agent class and the analyzer agent class through the same prompt override runtime subsystem.

5. The system of claim 1, wherein the override map is materialized on a generator agent class instance at instantiation time and is constructed from a serialized override dictionary persisted on a prior generation run record, such that re-invocation of the prompt resolution against the same persisted override dictionary produces an identical resolved prompt configuration.

6. The system of claim 1, wherein the prompt override runtime subsystem treats an empty-string override value as an intentional clearing of the prompt component, returning an empty string rather than falling back to the filesystem default, such that a prompt component may be intentionally suppressed from the assembled prompt configuration through the override map.

7. The system of claim 1, wherein the parent-run reference is a self-referential foreign key on the generation run record, and wherein the persistent run lineage subsystem supports forward queries retrieving all descendants of a given generation run and backward queries retrieving the ancestor chain of a given generation run by traversing the parent-run references until a root generation run with a null parent-run reference is reached.

8. The system of claim 1, wherein the serialized override dictionary is stored as a serialized text field rather than as a structured schema field, such that addition of new prompt component keys does not require a schema migration of the persistent run lineage subsystem.

9. The system of claim 1, wherein the persistent run lineage subsystem records, on each generation run record, a status field derived from the operational log and updated as the generation run progresses through pending, running, completed, and failed states, the status field being accessible to the analyzer agent class without loading the operational log content.

10. The system of claim 1, further comprising a batch generation subsystem configured to process a manifest of generation entries through concurrent chunked invocation of the generator agent class, each generation entry comprising a unique entry identifier and structured input parameters for a single generation run, the batch generation subsystem maintaining a stop signal that terminates further chunk invocation when set and a progress aggregate accessible by polling.

11. The system of claim 10, wherein the batch generation subsystem creates a generated-artifact container under a system-owned tenant organization scope for each generation entry, instantiates the generator agent class with the entry's structured input parameters and an entry-specific override map, and updates the manifest entry's status field upon completion or failure of the corresponding generation run.

12. The system of claim 1, wherein the generator agent class accepts at instantiation a parent-run reference parameter and records the parameter on the generation run created at the conclusion of the generation run, such that generation runs invoked from prior runs are linked to their parent runs in the persistent run lineage.

13. The system of claim 1, wherein the asymmetric data access surfaces of the single-run drill-down workflow and the cross-run synthesis workflow are enforced structurally through distinct data-loading functions, the data-loading function of the single-run drill-down workflow returning generated artifact content and the data-loading function of the cross-run synthesis workflow returning no generated artifact content, such that the analyzer's recommendations in the cross-run synthesis workflow are formed without bias from artifact surface features.

14. The system of claim 1, wherein the analyzer agent class computes the prompt diff between an override text and a corresponding filesystem default at the line level, producing a set of added lines and a set of removed lines, and includes a representation of the prompt diff in the data access surface of the single-run drill-down workflow.

15. The system of claim 1, wherein the override frequency aggregate computed by the analyzer agent class in the cross-run synthesis workflow records, for each prompt component key, the count of generation runs in which the prompt component key was overridden, the count being computed over the plurality of generation runs subject to synthesis.

16. The system of claim 1, wherein the analyzer agent class operates in two distinct workflows each governed by a distinct workflow-specific system prompt, the single-run drill-down workflow being governed by a first workflow-specific system prompt referring to the artifact content as available context and the cross-run synthesis workflow being governed by a second workflow-specific system prompt explicitly stating that artifact content is not loaded and instructing the analyzer to reason from notes and override patterns.

17. The system of claim 1, wherein the next-iteration structured action is emitted by the analyzer agent class as a structured user-interface element having attributes encoding the action fields, the structured user-interface element being consumed by a structured-action ingestion pipeline that parses the attributes into the next-iteration structured action object.

18. The system of claim 17, wherein the structured user-interface element encodes each per-prompt-key override field as a separate user-interface element attribute identified by a data attribute carrying the prompt-component key, such that the addition of an additional per-prompt-key override field does not require restructuring of the structured user-interface element and does not require modification of the structured-action ingestion pipeline.

19. The system of claim 1, wherein the successor-generation handler constructs the override map for the successor generation run by merging the parent run's persisted override dictionary with the per-prompt-key override fields of the next-iteration structured action, such that the successor run inherits the parent's override configuration except for the prompt components specifically overridden by the next-iteration action.

20. The system of claim 1, wherein the registered handler table is shared with a controlled-execution platform and the next-iteration structured action is subject to the same dispatch validation, atomic transaction execution, and chain-of-custody audit as other validated structured directives in the controlled-execution platform.

21. The system of claim 1, further comprising a human-judgment capture subsystem configured to receive a notes-update structured action from the analyzer agent class's single-run drill-down workflow, validate the notes-update structured action against a notes schema, and dispatch the validated action through the registered handler table to a notes-update handler that persists the notes to the human-recorded notes field of the target generation run record.

22. The system of claim 1, wherein the cross-run synthesis workflow of the analyzer agent class treats the human-recorded notes as a primary input and distinguishes generation runs having recorded notes from generation runs lacking recorded notes, the analyzer being instructed to recommend that the user record notes for runs lacking recorded notes before further cross-run synthesis is performed.

23. The system of claim 1, wherein the persistent run lineage subsystem records generation runs under a tenant organization scope and the analyzer agent class restricts cross-run synthesis to generation runs under the analyzer's tenant organization scope, such that the analyzer cannot access generation runs across tenant boundaries.

24. The system of claim 10, wherein the batch generation subsystem operates under a tenant organization scope, and each generated-artifact container created by the batch generation subsystem records the tenant organization scope on the corresponding generation run record for use in cross-run synthesis tenant scoping.

25. The system of claim 1, wherein the persistent run lineage forms a directed acyclic graph in which root generation runs are nodes with a null parent-run reference and derivative generation runs are nodes with a non-null parent-run reference, the directed acyclic graph being traversable in both forward and backward directions to reconstruct any iteration history.

26. The system of claim 1, wherein the persistent run lineage subsystem stores each generation run record together with the parent-run reference forming the iteration lineage graph, such that the iteration lineage graph is reconstructable from the parent-run references stored on the generation run records.

27. The system of claim 1, wherein the next-iteration structured action carries the proposed per-prompt-key override fields and the parent-run reference, and is validated against the predetermined schema for the next-iteration structured action prior to dispatch through the registered handler table.

28. The system of claim 27, wherein the registered handler table maps the next-iteration structured action to a successor-generation handler that invokes the generator agent class with the merged override map derived from the proposed per-prompt-key override fields and records the parent-run reference on the resulting successor generation run record.
